(19) United States
(12) Patent Application Publication
(10) Pub. No.: US 2005/0065061 A1
(43) Pub. Date: Mar. 24, 2005

(54) Method of remediating PCB contamination on metal surfaces

(76) Inventor: William B. Spence, Pittsburgh, PA (US)

Correspondence Address: ECKERT SEAMANS CHERIN & MELLOTT, 600 GRANT STREET, 44TH FLOOR, PITTSBURGH, PA, 15219, US

(21) Appl. No.: 10/669,733

(22) Filed: Sep. 24, 2003

(51) Int. Cl. C11D 1/00

(52) U.S. Cl. 510/506

(57) ABSTRACT

A method of remediating PCB contamination on metal surfaces. The method includes contacting the metal surface with a pollution remedial composition comprising a sodium silicate, a surfactant and a polyol with the remainder being water.

### BACKGROUND OF THE INVENTION

1. Field of the Invention

This invention relates to a method of remediating polychlorinated biphenyl (“PCB”) contamination on metal surfaces.

2. Description of the Prior Art

Many years ago, metal surfaces, such as sections of battleships, were painted with a primer that contains PCB'S. At that time, the alleged danger of PCB's (e.g., that they are carcinogenic) were not known. Now, in an attempt to use or sell these battleships (the so-called “ghost fleet”), there is a need for fast, economical and efficient remediation of the PCB's in order to either make these ships usable or use the metal of the ships as recyclable scrap.

My U.S. Pat. No. 6,436,884, the disclosure of which is expressly incorporated by reference herein, disclosed a pollution remedial composition and method. The composition includes a soluble silicate, a surfactant, a polyol and the remainder water. The soluble silicate is preferably sodium silicate. The surfactant is preferably Tergitol brand surfactant and the polyol is preferably polyethylene glycol. The remediation composition was disclosed to be useful in-situ (in soils) and on concrete surfaces. Examples of the success of these methods on PCB decontamination in soils and on concrete surfaces were presented.

Despite the success of my patented composition and method, there is still a need for a PCB decontamination process for metal surfaces that is fast, effective and economical.

### SUMMARY OF THE INVENTION

The invention herein has met or exceeded the above-mentioned needs, as well as others.

Other than a casual mention of steel surfaces in column 2, line 53, there is no teaching or suggestion in my patent of using the composition disclosed in my U.S. Pat. No. 6,436,884 for remediating PCB contamination on metal surfaces, such as sections of a ship. I have unexpectably found that this composition, when used in accordance with the method of this invention, will effectively remediate PCB contamination on metal surfaces. This result is obtained by the easy and economical method of the invention.

### DETAILED DESCRIPTION

As discussed above, PCB's were routinely used in primers that were painted onto metal surfaces, such as sections of ships. Once PCB's were regulated under the Toxic Substances Control Act (TSCA) of 1978, it was necessary to remediate, manage and dispose of PCB-containing substances. For the so-called “ghost fleet” of ships owned by the United States government, this means that these ships must be “moth balled” before being either sold to other countries, such as China or destroyed and used for scrap.

My method involves applying compositions similar to those disclosed in my U.S. Pat. No. 6,436,884 to the metal surface coated with the PCB-containing primer. The composition can be applied in any desired way, such as, without limitation, painting or spraying the composition onto the metal surface coated with the PCB-containing primer. The composition strips the chlorine atoms from the ring structures of polychlorinated biphenyl compounds. Upon completion of the reaction (which, because of catalysts, occurs at low temperatures) only non-toxic residues remain, thus eliminating the need for costly disposal and also long term liability associated with more traditional methods.

Broadly, the pollution remedial composition of the present invention contains more than 35 volume percent but less than 40 volume percent of a soluble silicate; from about 0.25 to 5 volume percent of a surfactant; from about 0.5 to about 5 volume percent of a polyol and the remainder water.

The soluble silicate is preferably a sodium silicate and the surfactant is an ethoxylated nonylphenol containing an average of 9.5 ethyleneoxy units per molecule, such as that sold under the tradename Tergitol. The polyol is preferably a polyethylene glycol. Most preferably, the following composition is representative of that used in the method of this invention:

| Component | Weight | Volume | Volume Percent |
|---|---|---|---|
| Sodium Silicate | 744.6 g | 19.25 gal | 38.5% |
| Polyethylene Glycol | 6.21 g | 0.25 gal | 0.5% |
| Tertigol (Surfactant) | 62.05 g | 2 gal | 4.0% |
| Water | 428.14 g | 28.5 gal | 57.0% |

As stated above, this composition is applied to the metal surface by any desired method, such as painting, spraying or power washing. The amount of the composition, and the intensity of the application of the composition to the surface will depend on the situation presented, however once the composition reaches the PCB, the remediation is instantaneous. It may be necessary to repeat the application when there is high PCB contamination, but it has been found that the extra step is usually not necessary.

### EXAMPLE

The following example is provided to illustrate the method of the invention.

Six coupon sized metal pieces from a U.S. battleship, which initially contained 280 ppm of PCB's had the composition set forth above painted on to their surfaces. The six pieces were then analyzed by standard laboratory analysis to determine the extent (in ppm) of remaining PCB's on the surface. The following table shows the amount of various PCB's (in ppm) remaining on the pieces:

| PCB | PIECE # | | | | | |
|---|---|---|---|---|---|---|
| TYPE (ppm) | 1 | 2 | 3 | 4 | 5 | 6 |
| PCB-1242 | <0.001 | <0.001 | <0.00 | <0.001 | <0.001 | <0.001 |
| PCB-1254 | 0.0048 | \| | \| | 0.0027 | 0.0064 | \| |
| PCB-1221 | <0.001 | \| | \| | <0.001 | <0.001 | \| |
| PCB-1232 | \| | \| | \| | \| | \| | \| |
| PCB-1248 | \| | \| | \| | \| | \| | \| |
| PCB-1260 | ↓ | ↓ | ↓ | ↓ | ↓ | ↓ |

As can be seen from above, the method of the invention effectively and efficiently remediated the PCB's contained in primer that was applied to the metal surfaces from an unacceptably high concentration of 280 ppm to, for the most part, trace amounts. There was no need for special treatment or disposal of the used composition once it was applied to metal surface. It will be appreciated that although the composition was painted onto the metal surfaces of these pieces, the method is not limited to this application method, and other application methods, such as (without limitation) spraying can be used.

While particular embodiments of the invention have been disclosed above for purposes of illustration, it will be evident to those skilled in the art that numerous variations of the details may be made without departing from the invention as defined in the appended claims.

1. A method of remediating PCB contamination on metal surfaces comprising the step of contacting said metal surface with a pollution remedial composition comprising:
more than 35 volume percent but less than 40 volume percent of a soluble silicate;
from about 0.25 to about 0.5 volume percent of a surfactant;
from about 0.5 to about 5 volume percent of a polyol; and
the remainder water.

2. The method of claim 1, including
contacting said metal surface with said pollution remedial composition by applying said pollution remedial composition to said metal surface.

3. The method of claim 2, including
applying said pollution remedial composition to said metal surface by painting said pollution remedial composition to said metal surface.

4. The method of claim 2, including
applying said pollution remedial composition to said metal surface by spraying on said pollution remedial composition to said metal surface.

5. The method of claim 4, including
power washing said pollution remedial composition onto said metal surface.

6. The method of claim 1, wherein
said metal surface is coated with a PCB-containing primer.

7. The method of claim 5, wherein
said metal surface is a section of a ship.

8. The method of claim 1, wherein
said soluble silicate is sodium silicate.

9. The method of claim 1, wherein
said surfactant is an ethoxylated nonylphenol containing an average of 9.5 ethyleneoxy units per molecule.

10. The method of claim 1, wherein
said polyol is a polyethylene glycol.

11. The method of claim 1, wherein
said soluble silicate is sodium silicate;
said surfactant is an ethoxylated nonylphenol containing an average of 9.5 ethyleneoxy units per molecule; and
said polyol is a polyethylene glycol.

12. The method of claim 1, wherein
said soluble silicate is about 38.5 volume percent of said composition;
said surfactant is about 4.0 volume percent of said composition;
said polyol is about 0.5 volume percent of said composition; and
the remainder of said composition is water.
